(19) United States
(12) Patent Application Publication
(10) Pub. No.: US 2011/0132991 A1
(43) Pub. Date: Jun. 9, 2011

(54) THERMOSTAT

(75) Inventors: Nicole Moody, Memphis, TN (US); Robert Schultz, Memphis, TN (US)

(73) Assignee: HUNTER FAN COMPANY, Memphis, TN (US)

(21) Appl. No.: 12/703,389

(22) Filed: Feb. 10, 2010

Related U.S. Application Data
(63) Continuation-in-part of application No. 12/631,896, filed on Dec. 7, 2009.

(51) Int. Cl. G05D 23/00

(52) U.S. Cl. 236/46 R; 236/94

(57) ABSTRACT

A thermostat (10) includes a housing (11) having a control panel (13) with a plurality of manually selectable input elements or input keys (15) and a display panel (17) for displaying various functions of the programmable thermostat. The programmable thermostat also includes a temperature sensor (18), a microprocessor (19) having memory for storing a default program set of default temperature and time values and a desired program set of desired temperature and time values. The thermostat also includes a “SAVE AWAY” feature or mode of operation. The SAVE AWAY mode is intended to be used so that the HVAC system operates as if the user is away from the house through the manual operation of the SAVE AWAY input key, even though the normal schedule program indicates that the user should be “home”. In use, the SAVE AWAY mode of operation overrides the program set associated with a normal schedule. The SAVE AWAY mode typically operates the cooling system of the HVAC system at an inputted desired temperature which is higher than that associated with the normal “schedule”, and operates the heating system of the HVAC system at an inputted desired temperature which is lower than that associated with the normal “schedule”. The overriding of the normal schedule results in the operation of the HVAC system at a more efficient level for a select period of time.

### REFERENCE TO RELATED APPLICATION

This is a continuation-in-part of U.S. patent application Ser. No. 12/631,896 filed Dec. 7, 2009.

### TECHNICAL FIELD

This invention relates to thermostats, and specifically to programmable electronic thermostats.

### BACKGROUND OF THE INVENTION

Thermostats have existed for many years. Recently, programmable thermostats have been designed to include programmable capabilities so that a user may select programs to operate on different days, different times, and different temperatures during each different time. The thermostat then controls a heating and/or cooling system (HVAC system) according to the programmed times and temperatures for each day. The use of these select program time intervals decreases the energy expenses associated with the running of the HVAC system by running the system at different temperatures when the homeowner is “away” from the home, i.e., the thermostat is programmed to operate the heating system at a cooler temperature setting and operates the cooling system at a higher temperature setting when the owner is suppose to be “away” according to the day and time programmed in the thermostat.

However, at times the owner does not conform to the pre-programmed schedule and is “home” when the system is programmed to operate the HVAC system as if the owner is “away”, or conversely, the owner is “away” when the system is programmed to operate the HVAC system as if the owner is “home”. The latter situation causes the HVAC is operate more than necessary and is therefore an inefficient use and a waste of resources.

Accordingly, it is seen that a need remains for a thermostat that is capable of overriding a pre-programmed schedule. It is to the provision of such therefore that the present invention is primarily directed.

### SUMMARY OF THE INVENTION

In a preferred form of the invention a programmable thermostat for controlling space conditioning equipment comprises a temperature sensor, a display panel, a clock, a processor, and memory coupled to the processor for receiving a schedule program set for at least one of a heating and cooling mode. The schedule program set is defined by a plurality of schedule time programs and corresponding schedule temperature programs for each of the at least one heating and cooling modes. The memory also receives an overriding program set for at least one of the heating and cooling mode. The overriding program set is defined by at least one overriding time and temperature program which includes an overriding temperature value and an overriding time length value. The thermostat also has a manually selectable input element for initiating the activation of the overriding program set, the processor allowing the overriding program set to control the operation of the controlling space conditioning equipment in accordance to the overriding program set rather than the schedule program set. The processor allows the overriding program set to operate for a select time period equal to the time length value which commences upon the actuation of said manually selectable input element. The processor deactivates the overriding program set upon the expiration of the overriding time and temperature program and returning the operation of the controlling space conditioning equipment in accordance to the schedule program set.

### BRIEF DESCRIPTION OF THE DRAWINGS

FIG. 1 is a schematic view of a thermostat embodying principles of the invention in a preferred form.

FIG. 2 is a schematic view of the thermostat of FIG. 1.

FIG. 3 is a schematic view of the thermostat of FIG. 1.

FIG. 4 is a schematic view of the thermostat of FIG. 1.

FIG. 5 is a schematic view of the thermostat of FIG. 1.

### DETAILED DESCRIPTION

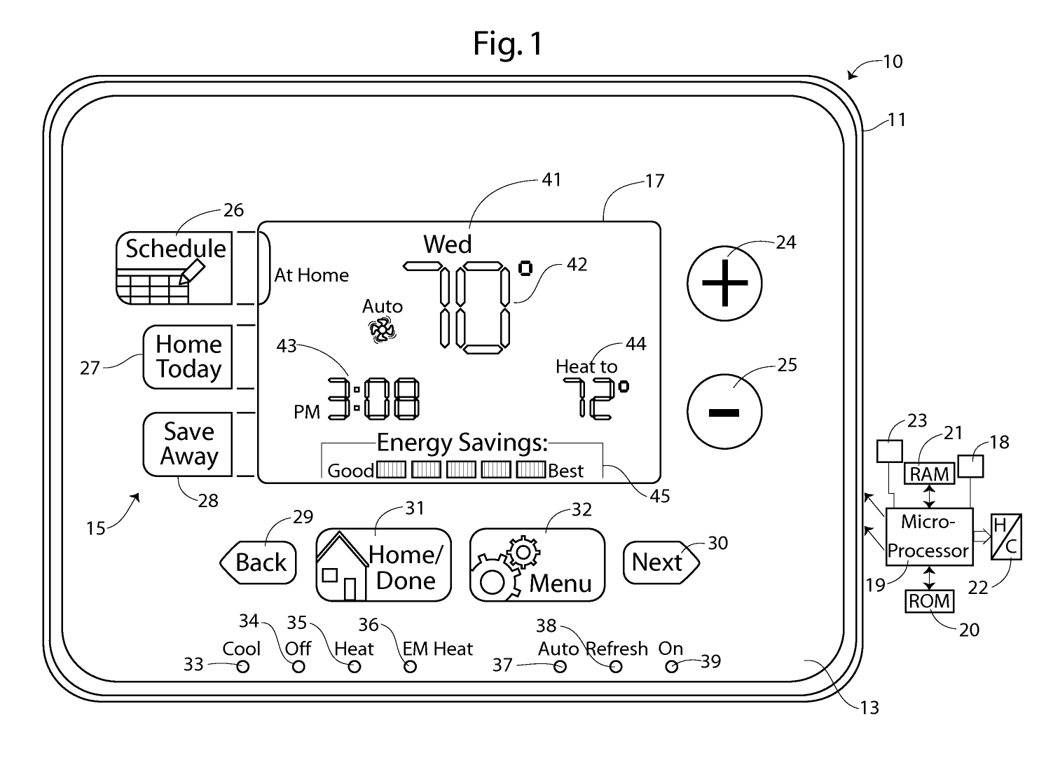

With reference next to the drawings, there is shown a thermostat 10 embodying principles of the invention in a preferred form. The thermostat 10 includes a housing 11 having a control panel 13 with a plurality of manually selectable input elements or input keys 15 and a display panel 17 for displaying various functions of the programmable thermostat, as depicted schematically in FIGS. 1-3. The design of the thermostat control panel 13 of the present invention may be of various sizes, shapes and configurations. The programmable thermostat 10 may include many different computer architectures, but generally requires a temperature sensor 18, a microprocessor or central processing unit (CPU) 19 having a permanent memory such as a read only memory (ROM) 20 for storing the program instructions for operation and control of the thermostat, a working memory or random access memory (RAM) 21 that retains or receives at least the particular program set for that day, and a clock 23. The program set, whether that be a default program set or a desired program set as is known in the art, includes a plurality of times and a plurality of temperatures over a given day associated with both a heating mode and a cooling mode. The microprocessor keeps track of the current day and the present time of day and determines which program of the various program sets the thermostat should be set in, when in its program mode, and then sets the temperature value and controls heating and/or cooling units 22 (HVAC space conditioning equipment) for the appropriate heating or cooling mode through relays, for example, as is well known in the art.

Programmable thermostats that include the present invention may be pre-programmed to enable the operator or user of the thermostat to create or program the thermostat to provide a default program set in the working memory, in accordance with an instruction manual that the user receives with the thermostat or in accordance with prompts that are displayed on the display panel 17. Alternatively, the default program set may be stored in the permanent memory by the thermostat manufacturer and this default program set may be automatically transferred into the working memory upon initialization of the thermostat.

The control panel 13 includes a plus “+” input key 24, a minus “−” input key 25, a “schedule” input key 26, a “home today” input key 27, a “save away” input key 28, a “back” input key 29, a “next” input key 30, a “home/done” input key 31 and a “menu” input key 32. The control panel 13 also includes a “cool” indicator 33, an “off” indicator 34, a “heat” indicator 35, an “EM heat” indicator 36, an “auto” indicator 37, a “refresh” indicator 38, and an “on” indicator 39. The functions of these keys and indicators are conventional and well known in the art, except for the “save away” input key 28.

The display panel 17 of the control panel 13 includes a number of display indicia that appears at different times upon the display, as best illustrated in the drawings and description of the programming method described herein. The display indicia includes a days of the week 41, current temperature 42, current time 43, desired temperature display 44, and an efficiency graphic 45 in the form of a five bar efficiency bar graph. Additional indicia that can be displayed are start times, end times, fan symbols, and other commonly used nomenclature associated with thermostats.

In use, the system is initially set up by entering the “day” (Monday through Sunday) and “time” utilizing the “+” input key 24 or “−” input key 25 until the appropriate day and time appear, the entry of which is indicated by a flashing “UPDATED” indicia after the Home/Done input key 31 is pressed.

The system then prompts the user to enter a desired program set of custom schedule which is associated with a plurality of desired time and temperature programs that include the entry of a desired temperature value and desired time value, indicated by the illumination of the display directly adjacent the “Schedule” input key 26, as shown in FIG. 1. The current period is displayed upon the display panel 17. If the user initially skips the schedule set-up process, then the default program set (pre-programmed) or schedule will go into effect. The default schedule provides for a fairly standard time schedule with temperature settings which provide comfort yet are high enough on the cool setting (cooling mode) and low enough on the heat setting (heating mode) to provide a very efficient mode of operation of the HVAC unit.

If the user wishes to program the thermostat with his or her own schedule (a desired program set) the user presses the Schedule input key 26. The user then selects the days (Monday through Friday) through the use of the “+” and “−” input keys, which turns the indicator arrow on the display on or off accordingly. The Next and Back input keys may be used to move to the next calendar day. The depression of the Home/Done input key takes the user to the period menu in order to select the time periods the user desires to program. Again, the user utilizes the “+” and “−” input keys to select the desired start and end times. The system may include distinct periods of time wherein the user is “AWAY”, “ASLEEP”, “AT HOME” or “OFF”. Again, the depression of the Home/Done input key progresses the program to the temperature selection segment.

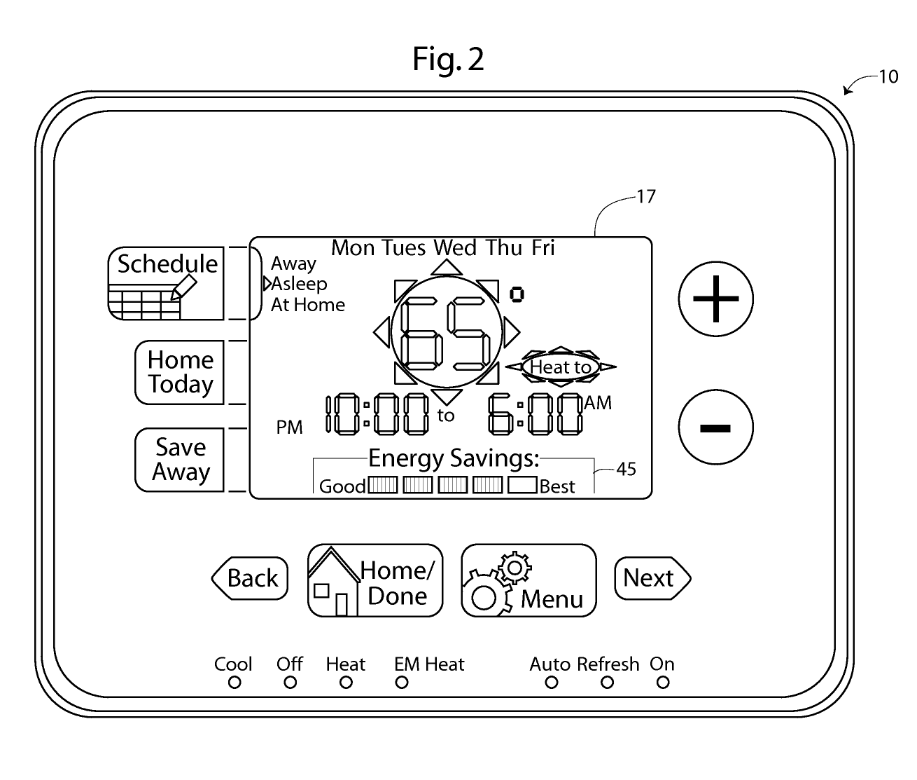

The user then uses the “+” and “−” input keys to change the desired temperature (one degree movement per depression) from the default temperature. The thermostat's microprocessor 19 compares the desired temperature value to the default temperature value of the cooling or heating mode and according to a preprogrammed algorithm graphically displays the systems efficiency through the use of the bar graph 45. For example, a deviation of 1 degree Fahrenheit from the default temperature will cause the bar graph to change from displaying 5 bars to the displaying of only 4 bars, thereby reducing the displayed efficiency from “BEST” to one bar below “BEST” or one bar closer toward “GOOD” as shown in FIG. 2. Continuing with this example, a 2 degree deviation from the default results in the display of 3 bars, a 3 degree deviation results in the display of 2 bars, and a 4 degree deviation results in the display of one bar (indicating a “GOOD” rating). Here, each one degree change from the default results in the removal of one bar from the bar graph. The algorithm that controls the display of the bars in the bar graph 45 may be based upon temperature variations from the default or a combination of temperature and time length variations from the default. Thus, a user can immediately recognize the change in the efficiency of the HVAC as a result in the change of the desired set temperature from the default set temperature.

A combination of temperature and time length variations may be best illustrated as follows: the thermostat is preprogrammed to include a default program set of a default time and temperature program settings. The first time and temperature program is a first time period or value of “AWAY” occurring between 8:00 am and 6:00 pm with a heating temperature setting or value of 63 degrees and a cooling temperature setting (cooling mode) or value of 82 degrees, a second time period of “ASLEEP” occurring between 10:00 pm and 6:00 am the next day with a heating temperature setting 67 degrees and a cooling temperature setting of 82 degrees, thus leaving a third time period of “AT HOME” occurring between 6:00 am and 8:00 am and between 6:00 pm and 10:00 pm with a heating temperature setting of 71 degrees and a cooling temperature setting of 74 degrees. A 1 degree increase in the set heating temperature, through an input of such in the desired program set, in the “AT HOME” third time period will normally result in the bar graph moving from showing 5 bars to only showing 4 bars, illustrating that the increase in the heating temperature results in a less efficient energy consumption. However, if the user additionally shortens the “AT HOME” third time period by 2 hours (increasing the “AWAY” first time period by 2 hours with a resulting decrease in the heating temperature setting for those 2 hours from 71 degrees to 63 degrees) the overall efficiency is computed to be equivalent to the default setting. Therefore, the system does not reduce the number of bars from 5 bars to 4 bars, but maintains the number at 5 bars. In other words, the increase in the temperature value of 1 degree for the “AT HOME” period is offset by the 2 hour increase in the “AWAY” period of time value at the lower 63 degree heating temperature. Again, a user can immediately recognize the change in the efficiency of the HVAC system efficiency as a result in the change of the desired set temperature from the default set temperature and a change in the time period from the default time period.

Similarly, if a user increases the “AT HOME” third time period without changing any temperature settings, the result may be the removal of a display bar to show the lower overall efficiency of the HVAC system. The reason for this is that the HVAC system is working a longer time at the higher temperature associated with the “AT HOME” time period as compared to the temperature associated with the “AWAY” time period, i.e., two hours have had their associated heating set temperatures changed from 63 degrees to 71 degrees.

It should be understood that even though the preferred embodiment graphically illustrates the efficiency of the set temperature through a bar graph, any type of graphic, symbolic, or dynamic illustration or visual cue such as through actual graphs, symbolic representations or nomenclature, numeric values, flashing lights, the frequency of flashing lights, or the like may be utilized to display such “graphically” on the display panel. It should also be understood that the algorithm utilized to determine the efficiency deduced from the time periods and temperature set points may be different from those used in the examples herein.

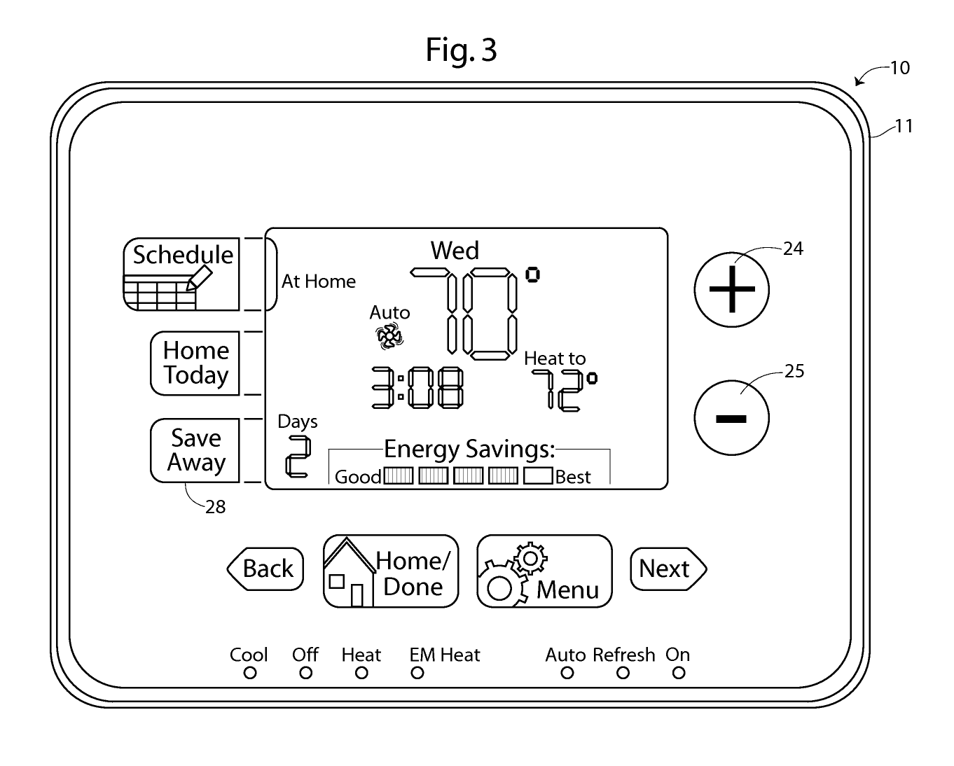

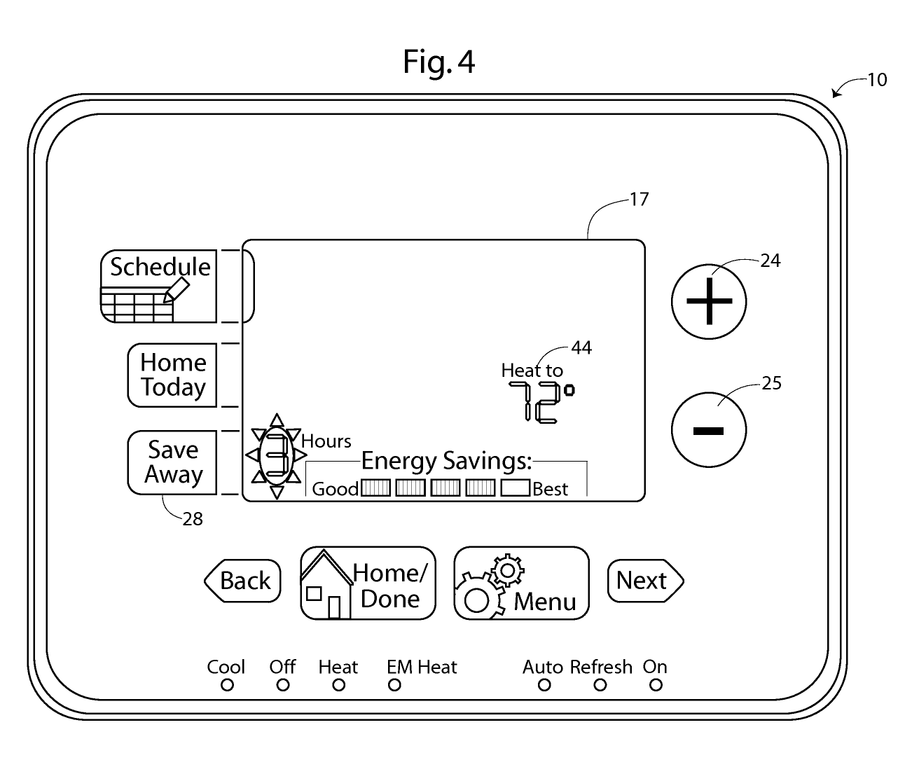

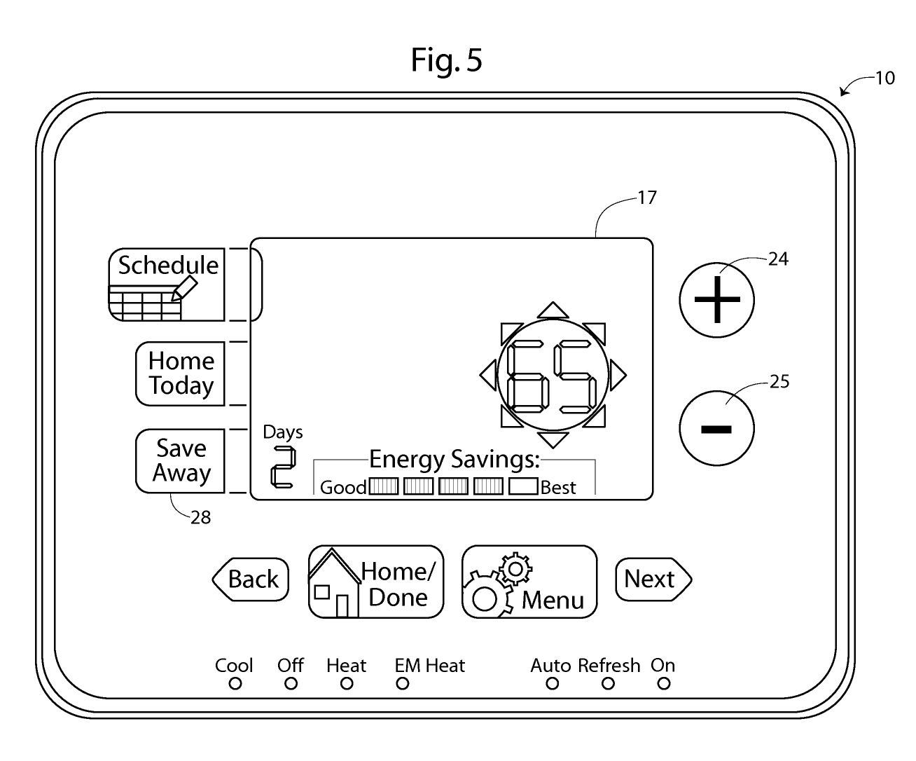

With reference next to FIGS. 3-5, a description of the “SAVE AWAY” feature or mode of operation is described in more detail. During the programming phase the thermostat allows the user to program a SAVE AWAY mode of operation. In order to do so, the user actuates or depresses the “save away” input key 28, which causes the system to display the word “hours” and highlight (by blinking or other highlighting technique) a default hour indication of “3” (example of a 3 hour default setting) upon the display panel 17, as shown in FIG. 4. The user may then increase or decrease the hour indication by using the “+” or “−” input keys 24 and 25, which increases or decreases the number of hours the system will operate in the SAVE AWAY mode. The system typically scrolls up by one hour increments until 12 hours is indicated, which the then causes the system to scroll up by days rather than hours, as shown in FIGS. 3 and 5. The switch from hours to days also causes the system to display the word “days” rather than “hours” on the display panel 17. The number of days may be increased to a maximum setting, which has been set to 30 days but which may be programmed to any default setting. Once the number of hours or days has been selected the user depresses the “next” input key 30, which causes the system to highlight the temperature upon the display panel 17 and allow the user to input the desired temperature, as shown in FIG. 5. The user again utilizes the “+” or “−” input keys 24 and 25 to arrive at the desired temperature. Once the desired temperature is set, the user depresses the “home/done” input key to save the desired number or hours or days and the desired temperature associated with the SAVE AWAY mode in memory. With the entry of these components, the system alerts the user that this data or parameters have been saved by displaying an indicator, such as the word “updated” upon the display panel.

It should be understood that the SAVE AWAY mode is intended to be used so that the HVAC system operates as if the user is away from the house, i.e., not present, even though the normal schedule program indicates that the user should be “home”. As such, the desired temperature entered into the thermostat is typically a very high temperature when associated with the cooling system and a very low temperature when associated with the heating system. With the entry of a high temperature with the cooling system or mode the HVAC system operates in a very efficient manner since it is doing a minimal amount of cooling. Similarly, with the entry of a low temperature with the heating system or mode the HVAC system operates in a very efficient manner since it is doing a minimal amount of heating.

In use, after the SAVE AWAY mode has been programmed, the subsequent depression of the “save away” input key 28 initiates a SAVE AWAY mode of operation which overrides the program set associated with a normal schedule. The depression causes the display panel to display an indicator symbol directly adjacent the “save away” input key 28. The overriding of the normal schedule occurs for the desired time period entered into memory which is associated with the SAVE AWAY mode before returning to the normal operation indicated by the program set associated with the normal “schedule”. The SAVE AWAY mode typically operates the cooling system of the HVAC system at an inputted desired temperature which is higher than that associated with the normal “schedule”, and operates the heating system of the HVAC system at an inputted desired temperature which is lower than that associated with the normal “schedule”. The overriding of the normal schedule results in the operation of the HVAC system at a more efficient level for a select period of time.

The SAVE AWAY mode is easily commenced through the push of a single stroke by the user of the “save away” input key. This allows the user a quick and easy manner of diverting from the normal “schedule” which does not require tedious reprogramming of the thermostat with every activation. This activation also overrides the normal schedule for a definite period of time, rather than an indefinite period of time associated with some overriding features of today's thermostats wherein an overriding button is depressed which initiates an overriding of the schedule that will continue until either the button is depressed again or the next schedule time commences.

It should be understood that he SAVE AWAY mode could be identified by some other indicia other than “save away” and the particular identification is not a limitation of the present invention. It is desired, however, to have a particular key that initiates the function of the present invention to include some indicia that a user would understand to perform the temporary resetting of the normal schedule or program set.

It thus is seen that a thermostat is now provided which overcomes problems with those of the prior art. While this invention has been described in detail with particular references to the preferred embodiments thereof, it should be understood that many modifications, additions and deletions, in addition to those expressly recited, may be made thereto without departure from the spirit and scope of the invention as described by the following claims.

1. A programmable thermostat for controlling space conditioning equipment comprising:
a temperature sensor;
a display panel;
a clock;
a processor;
memory coupled to said processor for receiving a schedule program set for at least one of a heating and cooling mode, said schedule program set defined by a plurality of schedule time programs and corresponding schedule temperature programs for each of the at least one heating and cooling modes, said memory also receiving an overriding program set for at least one of the heating and cooling mode, said overriding program set defined by at least one overriding time and temperature program which includes an overriding temperature value and an overriding time length value, and
a manually selectable input element for initiating the activation of said overriding program set;
said processor allowing the overriding program set to control the operation of the controlling space conditioning equipment in accordance to the overriding program set rather than the schedule program set, said processor allowing the overriding program set to operate for a select time period equal to the time length value which commences upon the actuation of said manually selectable input element, said processor deactivating said overriding program set upon the expiration of said overriding time and temperature program and returning the operation of the controlling space conditioning equipment in accordance to said schedule program set.

2. The programmable thermostat of claim 1 wherein said display panel also includes a graphic indicating that the overriding program set is activated.

3. The programmable thermostat of claim 1 wherein overriding program set is pre-programmed with default values entered into memory for the overriding temperature value and the overriding time length value.

4. A programmable thermostat for controlling space conditioning equipment comprising:
a temperature sensor;
a display panel;
a clock;
a processor including memory for receiving a plurality of schedule time program values and a plurality of schedule temperature program values associated with each schedule time program value, said memory also receiving an overriding time program value and an overriding temperature program value associated with said overriding time program value, and
a manually selectable input element;
said processor operating the controlling space conditioning equipment for a select definite time equal to said overriding time program value commencing upon the activation of said manually selectable input element and in accordance with said overriding temperature program value.

5. The programmable thermostat of claim 4 wherein said display panel also includes a graphic indicating that the overriding program set is activated.

6. The programmable thermostat of claim 4 wherein overriding program set is pre-programmed with default values entered into memory for the overriding temperature value and the overriding time length value.
